(19) United States
(12) Patent Application Publication
(10) Pub. No.: US 2015/0094409 A1
(43) Pub. Date: Apr. 2, 2015

(54) Fiber-Reinforced Polymer Composites With Flame-Resistant Properties

(71) Applicant: Ticona LLC, Florence, KY (US)

(72) Inventor: Paul Kenny, Holmen, WI (US)

(21) Appl. No.: 14/504,629

(22) Filed: Oct. 2, 2014

Related U.S. Application Data
(60) Provisional application No. 61/885,865, filed on Oct. 2, 2013.

(51) Int. Cl. C08K 5/529; C08K 3/22; B29C 70/52; C08K 3/32

(52) U.S. Cl. CPC C08K 5/529; C08K 3/32; C08K 3/22; B29C 70/52; C08K 2003/2296; C08K 2003/329; B29K 2023/12
USPC 524/100; 156/180

(57) ABSTRACT

Fiber composites are disclosed that have flame-resistant properties. The fiber composites can contain relatively long fibers having a fiber length of greater than 3 mm. The composites, in one embodiment, can be formed through a pultrusion process to produce continuous structures or pellets having a length of greater than 3 mm. The pellets can then be used to mold articles. In accordance with the present disclosure, the flame retardant composition contains a nitrogen and phosphorus compound, such as a pyrophosphate. The flame retardant is intumescent and can be halogen-free. The flame retardant composition can also be free of any flame suppressant.

### RELATED APPLICATIONS

The present application is based on and claims priority to U.S. Provisional Patent Application No. 61/885,865, filed on Oct. 2, 2013, which is incorporated herein by reference.

### BACKGROUND

A variety of thermoplastic polymers have been combined with fibers for different purposes. In one embodiment, the thermoplastic polymer is combined with fibers in order to increase the mechanical properties of the polymer, such as strength. In many applications, very short fibers are added to the thermoplastic polymer during melt processing to produce various different articles.

In an alternative embodiment, continuous fiber rovings can be impregnated with a thermoplastic polymer through a process known as pultrusion. During pultrusion, continuous fiber ravings are pulled through a heated impregnation zone where the rovings are contacted with a thermoplastic polymer composition. In one embodiment, strands are formed which can be wound for later use or cut to a desired length. In an alternative embodiment, greater amounts of the thermoplastic polymer composition are combined with the fiber rovings to form a rod-like product that can be cut to a desired length to form pellets. The pellets can then be fed to a molding device, such as an injection molding device, for producing shaped articles.

One problem faced by those skilled in the art in producing fiber-reinforced products, particularly pultruded products, is making the products flame resistant. Although almost a limitless variety of different flame retardants are marketed and sold commercially, selecting an appropriate flame retardant for a particular fiber-reinforced product is difficult and unpredictable. Further, many available flame retardants contain halogen compounds, such as bromine compounds, which can produce harsh chemical gases during production. Antimony Trioxide is also used as a synergist with halogenated systems. This compound contains levels of arsenic and lead. In view of the above, a need exists for a flame retardant composition that is compatible with a fiber-reinforced polymer product, and particularly a long fiber-reinforced polymer product. A need also exists for a flame retardant composition for incorporation into a fiber-reinforced polymer product that is halogen-free.

### SUMMARY

The present disclosure is generally directed to fiber reinforced composite polymer compositions and products including pellets, strands and molded articles, having flame-resistant properties. More particularly, the present disclosure is directed to long-fiber-reinforced composites that contain an intumescent and halogen-free flame retardant composition that provides the composite with excellent flame resistant properties.

In one embodiment, for instance, the present disclosure is directed to a fiber-reinforced composite polymer pellet or strand having flame-resistant properties. The composite polymer pellet or strand comprises reinforcing fibers contained in a polymer composition. The polymer composition comprises a thermoplastic polymer, such as a polyolefin polymer. In one embodiment, for instance, the thermoplastic polymer may comprise a polyethylene and/or polypropylene homopolymer, copolymer, or the like.

In accordance with the present disclosure, the polymer composition contains an intumescent and halogen-free flame retardant composition. The flame retardant composition comprises a nitrogen and phosphorus compound. For instance, the flame retardant composition can contain nitrogen in an amount from about 19% to about 23% by weight and phosphorus in an amount from about 16% to about 20% by weight. In one embodiment, the nitrogen and phosphorus compound comprises a piperazine pyrophosphate. In one embodiment, in addition to a pyrophosphate, the flame retardant composition can further comprise phosphoric acid and optionally a metal oxide, such as zinc oxide.

Of particular advantage, the flame retardant composition can be present in the fiber-reinforced composite polymer pellet or strand at relatively low amounts while still providing the desired flame-resistant properties. The flame retardant composition can provide the flame-resistant properties also without including a drip suppressant, such as a polytetrafluoroethylene polymer. In one embodiment, for instance, the flame retardant composition is present in the polymer pellet or strand in an amount less than about 24% by weight, such as in an amount less than about 22% by weight, such as in an amount less than about 20% by weight. The flame retardant composition is generally present in an amount greater than 5% by weight, such as in an amount greater than about 10% by weight, such as in an amount greater than about 15% by weight.

The present disclosure is particularly directed to rendering long fiber reinforced composite members flame-resistant. In this regard, at least 50% of the reinforcing fibers contained in the pellet or strand have a length of at least 3 mm. For instance, at least 50% of the reinforcing fibers can have a length of from about 3 mm to substantially the length of the respective pellet or strand. In one embodiment, the pellet or strand is formed through a pultrusion process in which continuous fibers are impregnated with the thermoplastic polymer composition. In order to form pellets, the extruded structure can be chopped or cut as it is formed. Impregnated strands (which includes ribbons) can remain continuous in length or can be cut at periodic intervals.

Various molded articles can be made from the fiber-reinforced polymer pellet or strand. Such molded articles include a fan or chute for a clothes dryer, a cover for a breaker box, or a part for a conveyor system.

Other features and aspects of the present disclosure are discussed in greater detail below.

### BRIEF DESCRIPTION OF THE DRAWINGS

A full and enabling disclosure of the present disclosure is set forth more particularly in the remainder of the specification, including reference to the accompanying figures, in which:

FIG. 1 is a cross sectional view of one embodiment of an injection molding system that may be used to mold polymeric articles in accordance with the present disclosure;

FIG. 2 is a perspective view of a conveyor component that may be made in accordance with the present disclosure;

FIG. 3 is a perspective view of a breaker cover that may be made in accordance with the present disclosure; and

FIG. 4 is a perspective view of a fan for a clothes dryer that may be made in accordance with the present disclosure.

Repeat use of reference characters in the present specification and drawings is intended to represent the same or analogous features or elements of the present invention.

### DETAILED DESCRIPTION

It is to be understood by one of ordinary skill in the art that the present discussion is a description of exemplary embodiments only, and is not intended as limiting the broader aspects of the present disclosure.

The present disclosure is generally directed to fiber-reinforced polymer composites that have flame-resistant properties. The present disclosure is particularly directed to “long fiber” reinforced composites that have flame-resistant properties. For instance, in one embodiment, the composite according to the present disclosure contains reinforcing fibers in which at least 50% of the fibers have a length greater than 3 mm, such as greater than 5 mm, such as from about 5 mm to about 12 mm. In one embodiment, a polymer composite can be produced according to the present disclosure that has a continuous length. The continuous length composite may comprise a strand. As used herein, strands are intended to also include impregnated ribbons.

In order to form long fiber reinforced composites, in one embodiment, a pultrusion process may be used. During pultrusion, continuous fibers are fed into a process and impregnated with a thermoplastic composition to form a composite structure. The composite structure can be wound in a continuous form or can be chopped or cut to form pellets. The composite structures can then be used to produce other articles. For instance, the pellets may be fed to an extrusion process for producing molded articles.

In accordance with the present disclosure, a flame retardant composition is incorporated into a thermoplastic polymer composition that is combined with reinforcing fibers. In accordance with the present disclosure, the polymer composition is combined with an intumescent and halogen-free flame retardant composition. The flame retardant composition comprises a nitrogen and phosphorus compound. The flame retardant composition, for instance, can have a nitrogen content of from about 19% to about 23% by weight and can have a phosphorus content of from about 16% to about 20% by weight. In one particular embodiment, the phosphorus compound comprises a pyrophosphate, such as piperazine pyrophosphate. In addition to the nitrogen and phosphorus compound, the flame retardant composition can contain a second phosphorus containing component, such as phosphoric acid. Optionally, the flame retardant composition can also contain a metal oxide, such as zinc oxide.

The flame retardant composition is intumescent meaning that the flame retardant composition swells when exposed to heat. For instance, when heated, the flame retardant composition may release gases that cause the composition to “puff up” and possibly form a foam-like structure. This expansion of the material assists in extinguishing flames.

It has been discovered that the intumescent flame retardant composition of the present disclosure synergistically associates with the long fibers contained in the composite to produce excellent flame-resistant properties. Although unknown, it is believed that the intumescent flame retardant composition swells when heated and works synergistically with the natural relaxation of the long fibers contained in the composite to assist in char formation and assist in flame resistance. In fact, the combination of the long fibers with the intumescent flame retardant composition has been shown to produce composite products having excellent flame resistance without the need for a drip suppressant. In this regard, polymer composites can be made according to the present disclosure that are free from a drip suppressant, such as a polytetrafluoroethylene polymer or additive.

In addition to the above, in one embodiment, the flame retardant composition is halogen-free.

Another advantage to the present disclosure is that polymer composites can be produced having the desired flame-resistant properties without having to add excessive amounts of the flame retardant composition. In the past, for instance, when using halogen-free flame retardants without a drip suppressant, greater amounts of the flame retardant were added to the polymer in order to obtain desired results. In the present disclosure, however, the flame retardant composition can be present in relatively low amounts without a flame suppressant and while still providing the desired properties.

The polymer composition of the present disclosure generally contains a thermoplastic polymer composition combined with a flame retardant composition and reinforcing fibers. One or more thermoplastic polymers are contained in the composition in an amount sufficient for the polymers to form a matrix that surround the reinforcing fibers. In general, the polymer composition of the present disclosure contains one or more thermoplastic polymers in an amount of from about 10% to about 85% by weight. For instance, the composition may contain one or more thermoplastic polymers in an amount greater than about 30% by weight, such as in an amount greater than about 40% by weight, such as in an amount greater than about 50% by weight, such as in an amount greater than about 60% by weight, such as in an amount greater than about 70% by weight.

In one embodiment, the composition contains a polyolefin polymer. The polyolefin polymer may comprise a polypropylene polymer and/or an ethylene polymer and may comprise a homopolymer, a copolymer, or a terpolymer.

In one embodiment, the polyolefin a) may be obtained by addition polymerization of ethylene or of an α-olefin, such as propylene, using a suitable catalyst. Examples of the polyolefin a) are homopolymers of high, medium, or low density, such as polyethylene, polypropylene, polymethylpentene, and copolymers of these polymers. The homopolymers and copolymers may be straight-chain or branched. There is no restriction on branching as long as the material is capable of shaping. It is possible to use a mixture made from two or more of these polymers. These materials are mostly semicrystalline homopolymers of α-olefins and/or ethylene, or copolymers of these with one another. One preferred polyolefin is polypropylene.

In addition to polyolefins, however, it should be understood that any suitable thermoplastic polymer may be contained in the composite as long as the thermoplastic polymer is compatible with the flame retardant composition. For instance, other thermoplastic polymers may comprise a polyamide, such as any suitable nylon. Other thermoplastic polymers include polyimides, polyvinyl chloride, polyaromatics, and styrenic polymers.

According to the present disclosure, the reinforcing fiber is not restricted to a particular material. Use may be made of reinforcing fibers made from a material with a high melting point (softening point), such as talc, wollastonite, glass fiber, carbon fiber, metal fiber, aromatic polyamide fiber (e.g. Kevlar®), and fibers made from aromatic liquid crystalline polymer (E.g. Vectra®). According to the present disclosure, preference is given to the use of glass fiber. The glass fibers used are usually in the form of bundles with fiber diameters of from to 8 to 25 μm and with weights of from 500 to 4400 grams per 1000 m. The fibers are preferably surface-treated with a sizing in a manner known per se. The amount of the reinforcing fiber present in the long-fiber-reinforced composite made by a pultrusion process may be from about 5% to about 60% by weight, such as from about 10% to about 40% by weight. In one embodiment, reinforcing fibers are present in the composite in an amount from about 15% by weight to about 30% by weight.

The fiber bundles are obtained by taking a number of fibers, treating these with an aqueous solution or aqueous emulsion of a size system, and then bundling the fibers. Preference is given to the use of wound fiber bundles which are bundled, dried, and wound onto creels (direct roving). As fiber rovings are conveyed through the impregnation zone, the ends are spliced to another bundle on a separate creel as conventionally practiced.

In accordance with the present disclosure, in addition to a polymer composition and to reinforcing fibers, the composite further contains a flame retardant composition. In one embodiment, the flame retardant composition contains an intumescent flame retardant. The flame retardant composition may also be halogen-free. In one embodiment, however, a halogen-based flame retardant may also be present.

In general, the flame retardant composition contains one or more phosphorus compounds. In one embodiment, one phosphorus compound contains both phosphorus and nitrogen. For instance, the phosphorus and nitrogen compound may comprise a pyrophosphate. An example of a pyrophosphate is piperazine pyrophosphate. The pyrophosphate may be present in the flame retardant composition in an amount from about 30% to about 80% by weight, such as in an amount from about 50% to about 70% by weight. The flame retardant composition may also contain a second phosphorus compound, such as phosphoric acid. The second phosphorus compound may be present in an amount from about 20% to about 60% by weight, such as in an amount from about 30% to about 50% by weight. Optionally, the flame retardant composition may also contain a metal oxide, such as zinc oxide. The metal oxide is generally present in an amount less than about 10% by weight, such as in an amount from about 2% to about 8% by weight based upon the weight of the flame retardant composition.

The flame retardant composition is present in the composite in an amount from about 5% to about 35% by weight. In one embodiment, however, the flame retardant composition can be present in the composite at relatively low amounts. For instance, the flame retardant composition may be present in an amount less than about 24% by weight, such as in an amount less than about 22% by weight, such as in an amount less than about 20% by weight. Of particular advantage, the flame retardant composition, in one embodiment, may not contain a drip suppressant, such as a polytetrafluoroethylene polymer.

Other additives may also be present in the fiber reinforced composites, for example lubricants, dyes, pigments, antioxidants, heat stabilizers, light stabilizers, particulate reinforcing agents, fillers, hydrolysis stabilizers and the like. The other additives present in the reinforced composites of the present disclosure preferably comprise at least one antioxidant and/or UV stabilizer and, where appropriate, a color masterbatch. The amount of antioxidant contained in the long-fiber-reinforced composite is suitably from 0.05 to 4.0% by weight, preferably from 0.15 to 3.0% by weight, particularly preferably from 0.2 to 2.0% by weight. In one embodiment, a phenolic antioxidant may be incorporated into the composition, such as a hindered phenolic compound.

A UV stabilizer can be present in the long-fiber-reinforced composite in an amount from 0.05 to 4.0% by weight, preferably from 0.15 to 3.0% by weight, and particularly preferably from 0.2 to 2.0% by weight. Various different UV stabilizers may be used including a hindered amine light stabilizer. In an alternative embodiment, a benzotriazole may be incorporated into the composition. In still another embodiment, the composition may contain a hindered amine light stabilizer and a benzotriazole each being present in the above amounts.

A color masterbatch if present in the long-fiber-reinforced composite is suitably employed at from 0.1 to 4.0% by weight, preferably from 0.15 to 3.0% by weight, and particularly preferably from 0.5 to 1.5% by weight.

According to a preferred process embodiment of the present disclosure, a continuous thermoplastic impregnated roving is pultruded, where I) fiber bundles are spread as they are pulled through a flat die charged with a melt comprising a polymer resin, the flame retardant composition, and additives at a temperature less than the degradation temperature of the polymers, II) the impregnated fiber bundles passes through the die within 1-2 seconds and then conducted through a shaping die, and Ill) the fiber bundles are cooled, and IV) the fiber bundles are cut cross-wise (perpendicular to the running direction), or are not cut, and wound up in the form of a continuous structure.

In one embodiment composite impregnated ravings are cut on-line by a rotary cutting die into pre-determined lengths, each comprising one or a plurality of fused impregnated fiber rovings as rod-shaped structures of length selected to be from 3 to 100 mm, preferably from 4 to 50 mm, and particularly preferably from 5 to 15 mm. The diameter of a non-consolidated rod-shaped structure, also termed a pellet, is from 1 to 10 mm, preferably from 2 to 8 mm, and particularly preferably from 3 to 6 mm. Consolidation of 10-200 individual rovings by fusing together by passing through a collection/shaping die results in rods of larger diameter, e.g. anywhere from 12-25 mm.

The present disclosure also provides a process where the components are mixed in an extruder, and the reinforcing fiber is wetted by the melt, and the resultant material is then pelletized. The resultant pellets may be mixed with dye and/or pigment and further processed.

According to the present disclosure, a shaped article can be molded from the molten, where appropriate colored, long-fiber-reinforced polyolefin pellets in a manner known per se, such as injection molding, extrusion, blow molding, or compression with plastification.

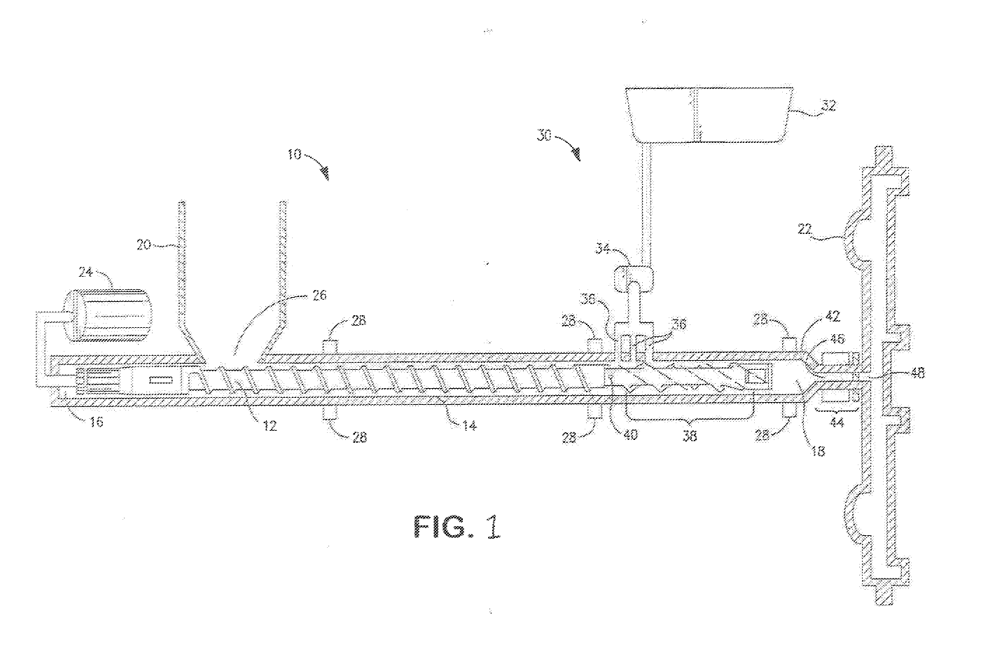

Referring to FIG. 1, for instance, one exemplary embodiment of an injection molding system generally 10 that may be used to form fiber reinforced polymer articles, including foam articles, in accordance with the present disclosure is illustrated. As shown, the molding system 10 includes a screw 12 contained within a barrel 14. The barrel 14 includes a first end 16 and a second end 18. The barrel 14 is in communication with a hopper 20 towards the first end 16 and in communication with a molding cavity 22 towards the second end 18. The screw 12 is in operative association with a drive motor 24 that causes the screw to rotate.

During the molding process, polymer pellets containing reinforcing fibers as described above are placed into the hopper 20 and are introduced into the barrel 14 through an opening 26. Within the barrel 14, the polymer pellets are heated into a molten state. The drive motor 24 rotates the screw 12 which then, in turn, pushes the molten polymer composite material down through the barrel and into the molding cavity 22.

In order to heat the composite polymer within the barrel 14, the barrel 14 can be in communication with any suitable heating device. For instance, the barrel 14 can be heated through electrical resistance heaters, gas heaters, and the like. In one embodiment, the heating device that heats the barrel 14 can be controlled so that different zones of the barrel are at different temperatures. In this regard, the barrel 14 can be in communication with a plurality of temperature control units 28. The temperature control units, for instance, can monitor the temperature of the barrel 14 and can send information to a controller, such as a microprocessor or programmable logic unit. The controller, in turn, can control the heating device for maintaining the temperature of the barrel at the various locations within preset temperature limits. The temperature control units can work in conjunction with a controller in a closed loop manner or in an open loop manner.

The injection molding system as shown in FIG. 1 can be used to form solid polymeric articles or, alternatively, can be used to form foam products.

In order to form a cellular or foam product, the molten polymer composite material moved through the barrel 14 is combined with a blowing agent prior to being fed to the molding cavity 22. In this regard, the barrel 14 can be placed in communication with a blowing agent delivery system generally 30. As shown, the blowing agent delivery system 30 includes a blowing agent supply 32 in communication with a pressure and metering device 34. From the blowing agent supply 32, a blowing agent is fed into the barrel 14 through at least one port 36. As shown, the barrel 14 can include a plurality of ports 36. For example, in the embodiment illustrated, the blowing agent delivery system 30 includes five ports 36. Each of the injection ports 36 may, if desired, be in communication with a shutoff valve which allow the flow of the blowing agent into the extruder barrel 14 to be controlled as a function of axial position of the rotating screw 12.

In general, any suitable blowing agent may be used in the process. The blowing agent, for instance, may comprise a physical blowing agent or a chemical blowing agent. Examples of suitable blowing agents include, for instance, hydrocarbons, chlorofluorocarbons, nitrogen, carbon dioxide, helium, and the like.

In one embodiment, the blowing agent may comprise a supercritical fluid. Supercritical fluids that may be used include, for instance, carbon dioxide, nitrogen, or combinations thereof. Supercritical fluids can be introduced into the barrel and made to rapidly form a single-phase solution with the polymer composite material either by injecting the additive as a supercritical fluid, or injecting it as a gas or liquid and allowing conditions within the extruder to render it supercritical.

The supercritical fluid can be present in the composite polymer material in an amount less than about 10% by weight, such as less than 5% by weight, such as less than 1% by weight, such as even less than about 0.5% by weight.

The pressure and metering device 34 is positioned in between the blowing agent supply 32 and the at least one port 36. The pressure and metering device 34 can be used to meter the mass of the blowing agent, such as between about 0.01 lbs/hr to about 70 lbs/hr.

The particular blowing agent used and the amount of blowing agent incorporated into the composite polymer material can be selected so as to produce a foamed product with the desired cell size and void volume.

As shown in FIG. 1, the one or more ports 36 are located within or upstream from a mixing section 38 of the screw 12. The ports 36 can be located at different locations along the barrel. In one embodiment, for instance, two ports may be positioned on opposing top and bottom sides of the barrel 14. A blowing agent entering the barrel 14 through the ports 36 rapidly and evenly mixes with the molten composite polymer material into a fluid polymer stream. When the blowing agent is a supercritical fluid, a single-phase solution is produced. Having a plurality of ports that are positioned radially around the barrel 14 may enhance mixing. Further, it should be understood that many more ports 36 may be positioned along the barrel 14.

As shown in FIG. 1, the screw 12 contained within the barrel 14 includes a first portion of flights or threads that are unbroken and a second portion 38 containing broken threads. In addition, the screw 12 can include a check valve 40 that separates a first section from a second section.

In one embodiment, the ports 36 are located opposite unbroken flights along the screw 12. In this manner, as the screw rotates, each flight passes or wipes each port periodically. This wiping increases rapid mixing of the blowing agent with the composite molten polymer material. In particular, the flights rapidly open and close each port as the screw 12 rotates. The result is the distribution of relatively finely-divided, isolated regions of blowing agent in the fluid polymer material immediately upon injection and prior to any mixing.

Once the blowing agent is combined with the composite molten polymer material, the resulting mixture is then fed through the mixing section 38 contained within the barrel 14. In the mixing section, the blowing agent becomes intimately mixed with the polymer. As described above, when a supercritical fluid is present, the fluid dissolves within the polymer.

The mixing section 38 can include a plurality of broken flights. More particularly, the flights include spaced apart gaps. The gaps allow better mixing of the components.

In the embodiment illustrated, the screw 12 includes less than six flights between the end of the screw and the ports 36. In particular, the screw 12 can include three to five flights, such as four flights within the mixing section.

The screw 12 can have a relatively low compression ratio. For example, the compression ratio of the screw 12 can be generally less than about 2.5:1, such as less than about 2.3:1, such as less than about 2.1:1. For instance, in one embodiment, the screw 12 can have a compression ratio of about 2:1. In other embodiments, however, the screw can have a compression ratio of greater than about 2.5:1.

After the composite molten polymer material and the blowing agent are combined together, as shown in FIG. 1, the resulting mixture enters an accumulation region 42. In the accumulation region 42, the temperature of the mixture can be carefully controlled along with other process conditions. When using a supercritical fluid as a blowing agent, a single-phase solution of polymer material and blowing agent containing fibers is accumulated prior to being injected into the molding cavity 22.

From the accumulation region 42, the mixture enters a pressure reducing section 44 constructed to include a pressure-drop pathway 46. The pressure of the polymer fiber and blowing agent mixture drops below the saturation pressure for the particular blowing agent concentration at a rate or rates facilitating cell formation and foaming. Cell formation is a process by which a homogeneous, single-phase solution of polymer material, in which is dissolved molecules of a species that is gas under ambient conditions, undergoes formations of clusters of molecules of the species that define sites from which cells grow to form a foam. A homogeneous, single-phase solution changes to a mixture in which sites of aggregation of at least several molecules of blowing agent are formed. The gas, in solution in a polymer melt, comes out of solution to form a suspension of bubbles within the polymer melt. When using a supercritical fluid, this transition occurs by changing the solubility of the blowing agent within the polymer. Cell formation occurs in the process through a rapid temperature and/or pressure drop.

The pressure reducing section 44 as shown in FIG. 1 can be located at different locations within the injection molding system. In the embodiment shown in FIG. 1, for instance, the pressure reducing section 44 defines a nozzle connecting the barrel 14 to the molding cavity 22. Thus, the pressure reducing section defines an opening 48 that releases the blowing agent, fiber and polymer mixture into the molding cavity 22.

The opening 48 and the pathway 46 can have any size sufficient for a foam to form within the molding cavity 22. In one embodiment, the pathway 46 and the opening 48 can be adjustable in order to achieve a desired density. Further, while the pathway 46 defines a cell forming pathway, some cell formation may also take place within the molding cavity itself as pressure on the polymer material drops at a very high rate during filling of the mold.

Injection of the molten composite polymer material and blowing agent into the molding cavity 22 results in the production of a cellular material that may be classified as a foam. During injection of the material into the molding cavity 22, cell growth occurs. If desired, the molding cavity 22 can include vents to allow gas escape during injection.

According to the present disclosure, the components other than the reinforcing fiber, may be mixed in the melt in a kneader or an extruder. The temperature is set above the melting point of the higher-melting polymer by from 5 to 100.degree.K, preferably from 10 to 60.degree.K. The mixing of the melt is complete after a period of from 30 seconds to 15 minutes, preferably from 1 to 10 minutes.

In one embodiment, the long-fiber-reinforced composite is used for producing moldings. The moldings produced from the long-fiber-reinforced composite of the present disclosure have excellent mechanical properties, in particular excellent impact strength, high heat resistance, and low deformability due to water absorption. Low warpage moreover gives the moldings improved precision of fit. The moldings may be produced from the long-fiber-reinforced composites of the present disclosure by the known processes, such as injection molding, compression molding, or blow molding.

The long-fiber-reinforced composite is preferably used for producing uncolored or colored moldings subjected to high mechanical and thermal stress, for example moldings in motor vehicle construction, particularly since the level of odor emission in the interior of a vehicle is very low.

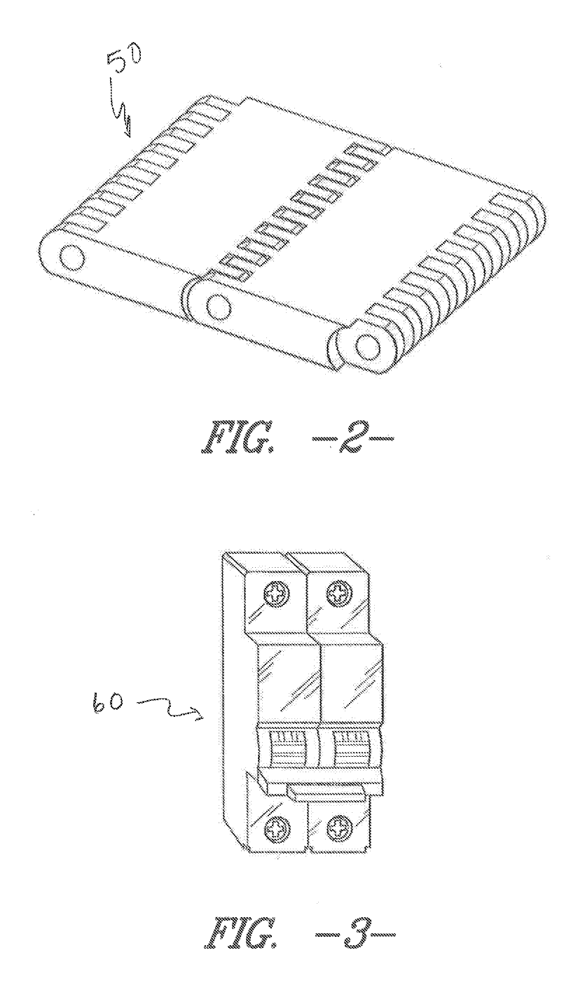

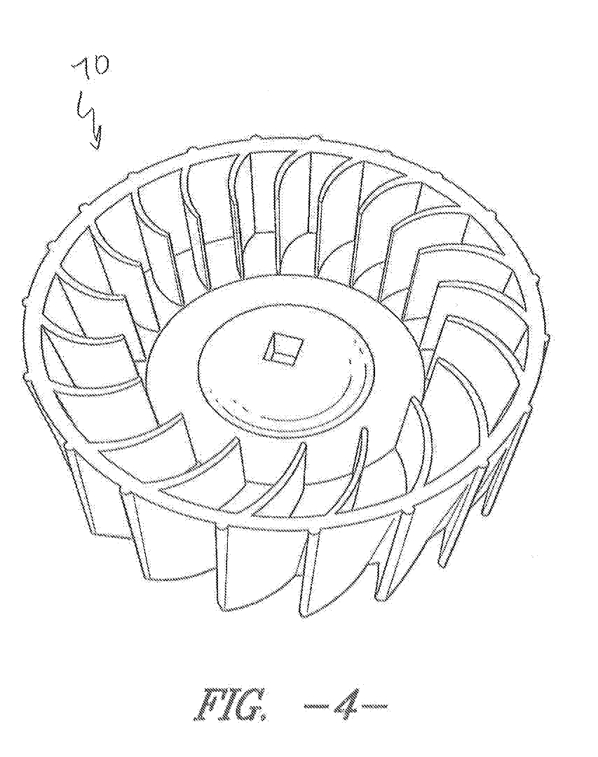

In addition to automotive parts, the composition of the present disclosure can also be used to produce various other articles for many different fields. For instance, as shown in FIG. 2, in one embodiment, the composition can be used to mold conveyor parts, such as conveyor part 50. As shown in FIG. 3, in another embodiment, the composition of the present disclosure may be used to produce a cover 60 for a breaker box. In still another embodiment, as shown in FIG. 4, the composition can be used to mold a fan 70 that may be used in a consumer appliance product, such as a clothes dryer.

Of particular advantage, composites and molded articles made according to the present disclosure have excellent flame resistant properties. For instance, when tested according to Underwriter Laboratories Test 94 according to the 20 mm Vertical Burn Test, composites made according to the present disclosure can have a UL-94 rating of V-0. The material can have a maximum flame time of less than 4 seconds, such as 3 seconds or lower. The composition may display no afterglow. When tested according to Underwriter Laboratories Test 94 the 125 mm Vertical Burn Test, the composite of the present disclosure may have a UL-94 rating of 5 VA and can have a maximum flame and afterglow time of less than 2 seconds, such as 1 second or less.

The present disclosure may be better understood with reference to the following example.

### Example

The following compositions were formulated and tested for flame resistance:

| Ingredients | Sample No. 1 | Sample No. 2 |
|---|---|---|
| Polypropylene polymer | 39 | 36 |
| Glass fibers | 40 | 40 |
| Flame retardant | 21% | 24% |
| composition | | |

The flame retardant composition contained piperazine pyrophosphate in an amount from 55 to 65% by weight, phosphoric acid in an amount from 35 to 45% by weight and zinc oxide in an amount from 3% to 8% by weight.

The above compositions were molded into test specimens that were 125 mm long×13 mm wide×3 mm thick. Five specimens of each sample were tested. The samples were tested according to Underwriter Laboratories Test 94 using the 20 mm Vertical Burn Test and the 125 mm Vertical Burn Test. During the 125 mm Verticle Burn Test, plaques were also molded. The plaques were approximately 100 mm long×115 mm wide×3.2 mm thick. During the 125 mm Vertical Burn Test, 3 plaques of each sample were tested. The following results were obtained:

### 1) UL94—20 mm Vertical Burn Test:

### Burn Test: Vertical Burning Test

A material classed 94V-0, 94V-1, and 94V-2 shall meet the following requirements:

| Criteria Conditions | 94V-0 | 94V-1 | 94V-2 |
|---|---|---|---|
| Maximum Flame Time, T1 or T2 | ≦10 s | ≦30 s | ≦30 s |
| Sum of all Flame Times, (T1 + T2) × 5 | ≦50 s | ≦250 s | ≦250 s |
| specimens | | | |
| Maximum Afterglow Time, T3 + T2 | ≦30 s | ≦60 s | ≦60 s |
| Did sample burn to holding clamp? | No | No | No |
| yes/no | | | |
| Did sample ignite cotton? yes/no | No | No | Yes |

T1 = first flame application,
T2 = second flame application,
T3 = after-glow time (all measured in seconds)

| | | Maximum | Sum of all | Maximum | | |
|---|---|---|---|---|---|---|
| | | Flame Time | Flame Times | Afterglow | Burn to | Ignite |
| Sample | UL-94 | T1 or T2 | T1 + T2 | Time T2 + T3 | Clamp | Cotton |
| Identification | Rating | (sec.) | (sec.) | (sec.) | (y or n) | (y or n) |
| Sample No. 1 | V-0 | 2 | 11 | 0 | N | N |
| Sample No. 2 | V-0 | 3 | 12 | 0 | N | N |

### 2) UL94—125 mm Vertical Burn Test:

### Burn Test: Vertical Burning Test

A material classed 94-5VA or 94-5VB shall meet the following requirements:

| Criteria Conditions | 94-5VA | 94-5VB |
|---|---|---|
| Maximum Flame and Afterglow Time | ≦60 s | ≦60 s |
| Did sample ignite cotton? yes/no | No | No |
| Did sample burn-through any plaque? | No | Yes |
| yes/no | | |

| | | Maximum Flame | | Burn through |
|---|---|---|---|---|
| Sample | UL-94 | and Afterglow | Ignite Cotton | plaque |
| Identification | Rating | Time (sec.) | (y or n) | (y or n) |
| Sample No. 1 | 5VA | 1 | N | N |
| Sample No. 2 | 5VA | 1 | N | N |

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended cairns.

What is claimed:

1. A fiber-reinforced composite polymer pellet or strand having flame-resistant properties comprising:
reinforcing fibers contained in a polymer composition, the polymer composition comprising a thermoplastic polymer; and
an intumescent and halogen-free flame retardant composition, the flame retardant composition comprising a nitrogen and phosphorus compound, and wherein at least 50% of the reinforcing fibers contained in the pellet or strand have a length of at least 3 mm.

2. A fiber-reinforced composite polymer pellet or strand as defined in claim 1, wherein at least 50% of the reinforcing fibers have a length of from about 3 mm to substantially the length of the respective pellet or strand.

3. A fiber-reinforced composite polymer pellet or strand as defined in claim 1, wherein the nitrogen and phosphorus compound comprises a piperazine pyrophosphate.

4. A fiber-reinforced composite polymer pellet or strand as defined in claim 1, wherein the flame retardant composition further comprises phosphoric acid and optionally zinc oxide.

5. A fiber-reinforced composite polymer pellet or strand as defined in claim 1, wherein the flame retardant composition is present in the polymer pellet or strand in an amount from about 10% up to 24% by weight.

6. A fiber-reinforced composite polymer pellet or strand as defined in claim 1, wherein the pellet or strand is free from any drip suppressants.

7. A fiber-reinforced composite polymer pellet or strand as defined in claim 1, wherein the pellet or strand is free from a polytetrafluoroethylene polymer.

8. A fiber-reinforced composite polymer pellet or strand as defined in claim 1, wherein the reinforcing fibers are present in the pellet or strand in an amount from about 5% to about 60% by weight and wherein the thermoplastic polymer is present in the polymer pellet or strand in an amount from about 30% to about 70% by weight.

9. A fiber-reinforced composite polymer pellet or strand as defined in claim 1, wherein the thermoplastic polymer comprises a polyolefin.

10. A fiber-reinforced composite polymer pellet or strand as defined in claim 1, wherein the thermoplastic polymer comprises a polypropylene.

11. A fiber-reinforced composite polymer pellet or strand as defined in claim 1, wherein the reinforcing fibers comprise glass fibers, talc fibers, wollastonite fibers, carbon fibers, metal fibers, aromatic polyamide fibers, or mixtures thereof.

12. A fiber-reinforced composite polymer pellet or strand as defined in claim 1, wherein the reinforcing fibers comprise cut fibers and wherein the pellet or strand has a length of from about 3 mm to about 100 mm.

13. A fiber-reinforced composite polymer pellet or strand as defined in claim 1, wherein the pellet or strand further contains at least one additive, the additive comprising an antioxidant, a UV stabilizer, a color master batch, or mixtures thereof.

14. A molded article made from the fiber-reinforced composite polymer pellet or strand as defined in claim 1.

15. A fiber-reinforced composite polymer pellet or strand as defined in claim 1, wherein the polymer pellet or strand comprises a pultruded product.

16. A fiber-reinforced composite polymer pellet or strand as defined in claim 1, wherein the flame retardant composition has a nitrogen content of from about 19% to about 23% by weight and has a phosphorus content of from about 16% to about 20% by weight.

17. A molded article as defined in claim 14, wherein the molded article comprises a fan or chute for a clothes dryer.

18. A molded article as defined in claim 14, wherein the molded article comprises a cover for a breaker box.

19. A molded article as defined in claim 14, wherein the molded article comprises a part for a conveyor system.

20. A fiber-reinforced composite polymer pellet or strand as defined in claim 1, wherein the polymer composition and the flame retardant composition form a composite that, when tested according to a 20 mm Vertical Burn Test according to Underwriter Laboratories Test 94, the composite has a rating of V-0 and has a maximum flame time of less than 4 seconds.

21. A pultrusion process for forming impregnated continuous fiber rovings comprising pulling said rovings at a velocity of at least 30 ft/min up to 500 ft/min through a heated impregnation zone where the rovings are impregnated with a polymer composition containing a thermoplastic polymer, the thermoplastic polymer comprising a polyolefin polymer, the polymer composition further comprising a halogen-free fire retardant composition comprising a nitrogen and phosphorus compound.
